(19) United States
(12) Patent Application Publication
(10) Pub. No.: US 2005/0060154 A1
(43) Pub. Date: Mar. 17, 2005

(54) Voice driven wireless pointer

(76) Inventor: Hariharan Kumar, Portland, OR (US)

Correspondence Address: KENYON & KENYON, 1500 K STREET, N.W., SUITE 700, WASHINGTON, DC, 20005, US

(21) Appl. No.: 10/962,685

(22) Filed: Oct. 13, 2004

Related U.S. Application Data
(62) Division of application No. 09/224,374, filed on Dec. 31, 1998, now abandoned.

(51) Int. Cl. G06F 3/00; G10L 17/00

(52) U.S. Cl. 704/246

(57) ABSTRACT

A voice driven wireless device for moving an image displayed on a screen and executing commands from the image's position is presented. According to an embodiment of the present invention, the apparatus comprises a transmitter and a receiver. The transmitter includes a pointing device (such as a trackball or a joystick) and a microphone. The receiver is adapted to be integrated with a screen or monitor. Position and voice signals are transmitted over a wireless medium from the transmitter to the receiver. The receiver sends received position and voice signals to the screen or monitor. A user, positioned away from the screen or monitor, uses the transmitter pointing device to position an image on the screen. Upon positioning the image on the screen, the user speaks a desired command into the transmitter microphone. The command is then executed at the image's position.

This is a division of application Ser. No. 09/224,374 filed 31 Dec. 1998, the content of which is incorporated herein by reference in its entirety.

### BACKGROUND

1. Field

The present invention pertains to pointing devices. More particularly, the present invention relates to a method and apparatus for moving an image displayed on a screen and using voice inputs to execute commands at the image's position.

2. Background Information

Display systems enable devices such as personal computers or televisions to show data to a user. The basic components of a display system include a graphics adapter and a monitor or other type of screen. The graphics adapter uses electrical signals from the computer or television to generate an image and project the image onto the monitor or screen. Most computer systems include an input device, known as a pointing device, to enable the user to manipulate images displayed on a monitor. The pointing device may enable the user to move a cursor or a displayed image from one location on the monitor to another location and/or to instruct an application program running on the computer to execute commands from the location of the image. A mouse is an example of a pointing device. A mouse may be attached to a personal computer and typically includes a trackball and two or three buttons. When the mouse is moved (using the trackball) a cursor or pointer on the computer's monitor moves in the same direction. The user may select images displayed on the monitor or instruct an application program running on the computer to execute commands by pressing one of the buttons on the mouse. Unfortunately, the cord which connects the mouse to the computer adds clutter to the user's work space and frequently becomes tangled around other objects. Additionally, the range of commands which the user can instruct the computer to execute using the mouse is limited by the number of buttons (typically no more than three) on the mouse.

One known method for eliminating the inconvenience of the mouse cord entails sending signals through the air (rather than through a cord) between the mouse and the computer. One product for accomplishing this goal is manufactured by Logitech Corporation (Freemont, Calif.). This product, known as the Logitech® Cordless Wheel Mouse is a three button mouse which communicates with a personal computer using radio frequency (RF) transmissions. However, the number of commands the user can instruct the computer to execute using the Cordless Wheel Mouse is limited because the product only includes three buttons.

Also known in the art is the SpeechMike product from Philips Electronics N.V. (Eindoven, Netherlands). The SpeechMike product includes a microphone built into a mouse and a cord for sending signals between the mouse and the computer. In addition to the well known mouse functions, SpeechMike enables the user to send voice commands to computer applications which include speech recognition capability. The requirement for an attached cord is one of the drawbacks of this product.

Accordingly, there is a need for a method and apparatus which solves the above described problems.

### BRIEF DESCRIPTION OF THE DRAWINGS

FIG. 1 is a:schematic diagram showing an apparatus according to an embodiment of the present invention.

FIG. 2 is a schematic diagram showing the apparatus of FIG. 1 integrated into a personal computer according to an embodiment of the present invention.

FIG. 3 is a schematic diagram showing the apparatus of FIG. 1 modified to include Bluetooth transceivers according to an embodiment of the present invention.

### DETAILED DESCRIPTION

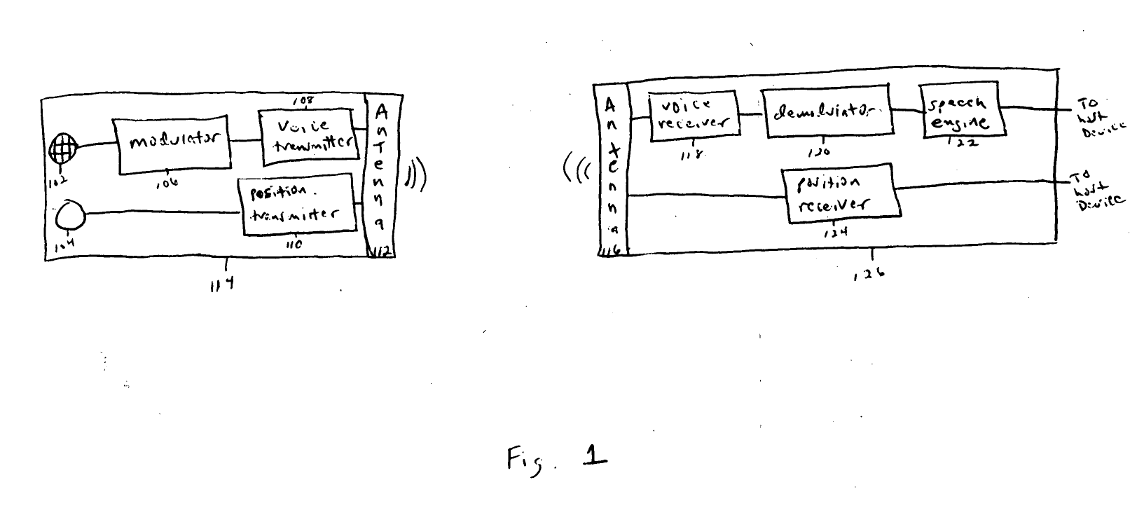

FIG. 1 is a schematic diagram showing an apparatus according to an embodiment of the present invention. In FIG. 1, a first component 114 (also referred to herein as a “pointer transmitter”) comprises a microphone 102 coupled to a modulator 106. A voice transmitter 108 is coupled to the modulator 106 and an antenna 112. The first component 114 also includes a pointing device 104 (such as a trackball, joystick, or other position capturing (sensing) device) coupled to a position transmitter 110. The position transmitter 110 is coupled to the antenna 112. A second component 126 (also referred to herein as a “pointer receiver”) comprises an antenna 116 coupled to both a voice receiver 118 and a position receiver 124. The voice receiver 118 is coupled to a demodulator 120. The demodulator 120 is coupled to a speech engine 122 (such as the ViaVoice by IBM, Philips, L&H, or Microsoft). Outputs of speech engine 122 and position receiver 124 are adapted to be coupled to a host device such as any broadcast receiver, a television (analog or high definition), a set top box, or a personal computer with a monitor or screen.

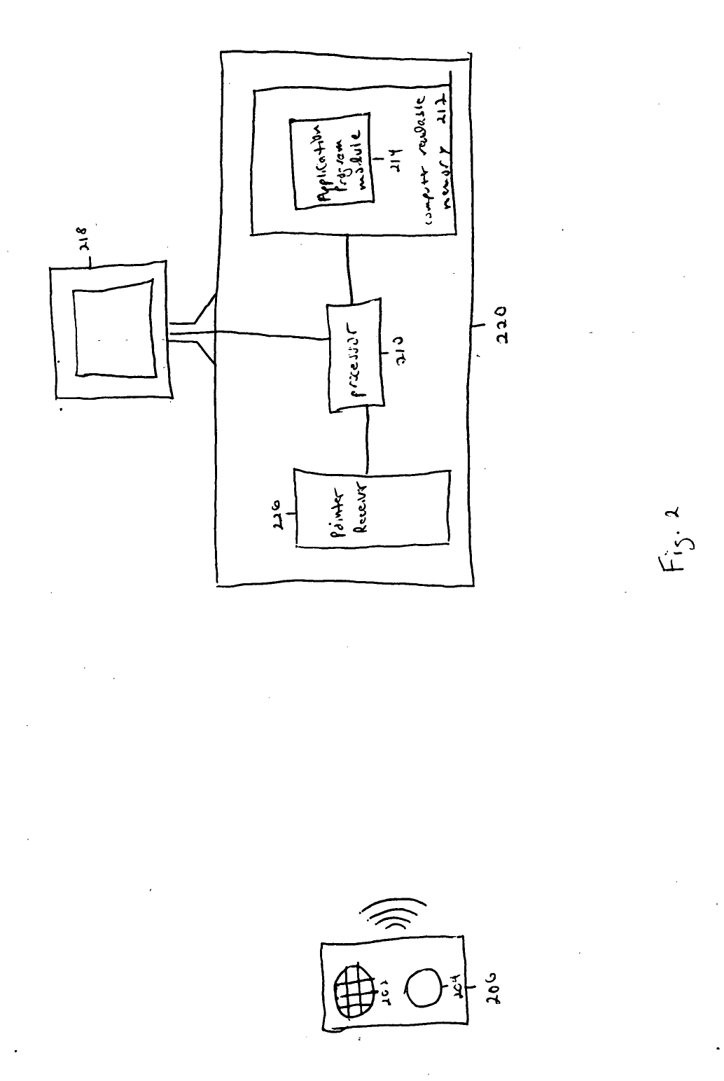

FIG. 2 shows the apparatus of FIG. 1 integrated into a personal computer according to an embodiment of the present invention. In FIG. 2, a pointer transmitter 206 (as described in FIG. 1) is shown with a microphone 202 and a trackball 204. A pointer receiver 226 (as described in FIG. 1) is coupled to a processor 210 of personal computer 220. Processor 210 is coupled to a computer readable memory 212 and a monitor 218. Computer readable memory 212 stores computer program code segments which are executed by processor 210. As shown, these code segments are included within an application program module 214.

The method for moving an object displayed on a monitor or screen and executing commands at the displayed object's position, in accordance with the present invention, will now be described with reference to FIG. 1 and FIG. 2. Assume processor 210 is executing application program module 214 which includes program code segments for a combat related video game. During execution, the video game projects images of human beings and other objects on monitor 218. A user may interact with this video game application using an input device to move the displayed images from one location on the monitor to another monitor location. In addition to moving images on the monitor, the computer application permits the user to input commands which instruct the application to execute actions such as firing a weapon held by a displayed human image or causing the displayed human image to jump to avoid a weapon fired by an opponent.

To move a human image from one position on the screen to another, the user moves trackball 204 on pointer transmitter 206 in the desired direction. Trackball 204 sends a corresponding position input signal to position transmitter 110. Position transmitter 110 modulates the received position signal on a radio frequency (RF) carrier frequency and sends the modulated signal to antenna 112. Antenna 112 transmits the modulated position input signal through the air to pointer receiver 226. The modulated positioning input signal is received by antenna 116 of pointer receiver 226. Position receiver 124 receives the modulated position input signal from antenna 116, demodulates the modulated signal, and sends the demodulated signal (also referred to herein as the “position output signal”) to application program module 214 through processor 210. Upon recognizing the position output signal, execution of application program module 214 moves the displayed image in accordance with the user's input to trackball 204.

Suppose the user wishes to cause a human image displayed on monitor 218 to fire a weapon held by the displayed image. First, depending on the particular video game application, the user might select the appropriate image by placing a cursor on the displayed image using trackball 204. Next, the user speaks the appropriate voice command (such as “fire”) into microphone 202. Microphone 202 then sends this voice input signal to modulator 106. Modulator 106 modulates the received voice signal on a carrier frequency and sends the modulated signal to voice transmitter 108. Voice transmitter 108 sends the modulated signal to antenna 112. Antenna 112 then transmits the modulated voice input signal through the air to pointer receiver 226. Voice receiver 118 receives the modulated voice input signal from antenna 116 and sends the modulated signal to demodulator 120. Demodulator 120 demodulates the voice input signal and sends the demodulated signal to speech engine 122. Speech engine 122 identifies the voice input signal and sends a corresponding output signal (referred to herein as the “command output signal”) to application program module 214 through processor 210. Upon recognizing the command output signal, execution of application program module 214 fires the weapon held by the human image in accordance with the user's instructions.

The range of different output signals a user may send to an application program is greatly enhanced when speech (rather than two or three mouse buttons) is employed by the user. In the context of the above described apparatus (assuming the speech engine produces a different output signal for each identified voice input), the range of output signals from the speech engine may be limited by the range of voice inputs signals the speech engine is programmed to recognize. This available range of output signals may easily surpass the range of different output signals which may be generated using the two or three buttons of a conventional mouse. If a particular application program is written to process signals from a conventional two or three button mouse and the application program is unable to process the full range of output signals available from a speech engine, each output signal from the speech engine of the present invention may need to be converted to a conventional mouse or keyboard output signal (such as RS 232 or PS/2) before the signal may be processed by the application program. This conversion may take place either within the apparatus of the present invention, within the host device, or within the particular application program running on the host device.

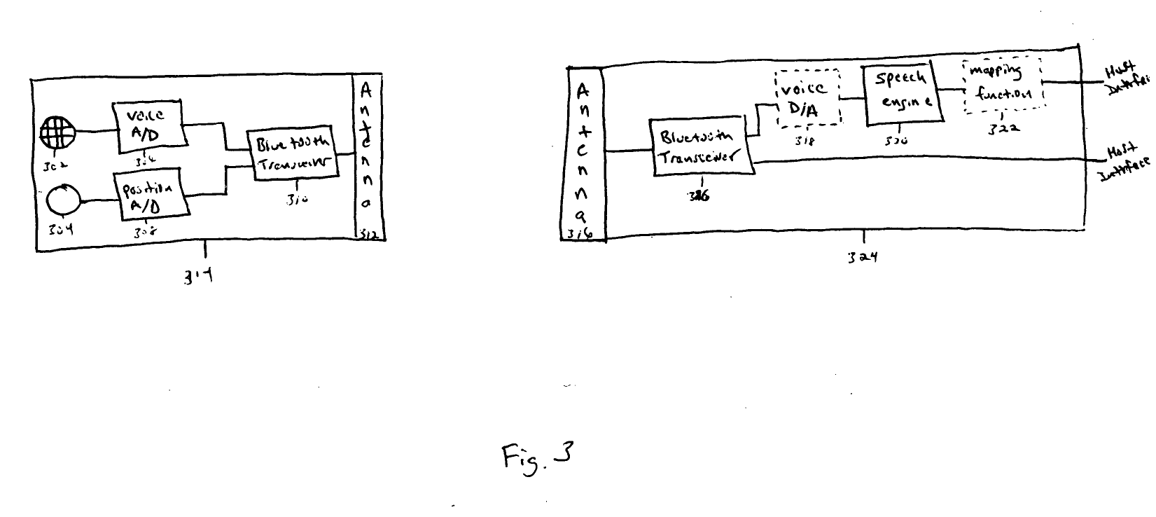

Another method for implementing wireless communication between the pointer transmitter and the pointer receiver of the present invention entails adapting each device to include radio transceivers configured to operate according to Bluetooth technology (described in greater detail below). FIG. 3 is a schematic diagram showing the apparatus of FIG. 1 modified to include Bluetooth transceivers according to an embodiment of the present invention. In FIG. 3, a pointer transmitter 314 comprises a microphone 302 adapted to be connected to a voice analog-to-digital (A/D) converter 306. Voice A/D converter 306 is adapted to be connected to a Bluetooth transceiver 310 (described below). Bluetooth transceiver 310 is adapted to be connected to an antenna 312. Pointer transmitter 314 also comprises a pointing device 304 such as a trackball or a joystick adapted to be connected to a position A/D converter 308. Positioning A/D converter 308 is adapted to be connected to Bluetooth transceiver 310. A pointer receiver 324 comprises an antenna 316 adapted to be connected to a Bluetooth transceiver 326. A first output of Bluetooth transceiver 326 is adapted to be connected to a voice digital-to-analog (D/A) converter 318. A speech engine 320 is adapted to be connected to voice D/A converter 318 and a mapping function 322. Mapping function 322 is adapted to be interfaced with a host device (not shown). A second output of Bluetooth transceiver 326 is also adapted to be interfaced with the host device.

The operation of the embodiment of FIG. 3 will be described after the following description of Bluetooth technology (Jaap Haartsen et al., Bluetooth: Vision, Goals, and Architecture, ACM Mobile Computing and Communications Review, Volume 2, Number 4, October 1998, pp 38-45.). Bluetooth technology enables devices equipped with radio transceivers to communicate using a frequency hopping modulation scheme within the 2.4 GHz Industrial, Scientific, and Medical (ISM) frequency band. In one Bluetooth embodiment, a transceiver within a first Bluetooth device receives audio and/or data information from the first Bluetooth device, uses the received audio and/or data information to form packets, modulates the packets on a carrier frequency, and transmits the modulated packets over a medium (such as air) to a transceiver within a second Bluetooth device. The transceiver in the second Bluetooth device, demodulates the received packets, extracts the audio and/or data information from the packets, and transmits the audio and/or data information to the second Bluetooth device.

The Bluetooth frequency hopping modulation scheme reduces interference in a noisy radio environment by ensuring each packet of data is modulated on a different carrier frequency than the carrier frequency of the previously transmitted or received packet. For example, each Bluetooth transceiver may be assigned a specific pattern for hopping among 79 different carrier frequencies within the 2.4 GHz band. At the start of communication between two Bluetooth equipped devices, the device which initializes communication may be temporarily designated as the “master” device and the recipient device is temporarily designated as a “slave” device. In one Bluetooth example, communication between the master and the slave is synchronized to the master's frequency hopping pattern.

Bluetooth equipped devices may form communication networks known as piconets. A piconet may comprise a master device and one or more slave devices. Each piconet may be defined by a different frequency hopping pattern. In one Bluetooth example, all devices participating in the same piconet may be synchronized to the same frequency hopping pattern.

“Ad hoc” communication between Bluetooth devices may be accomplished by assigning a unique address to each device. Once connections are made using these unique addresses, one Bluetooth device may address other connected Bluetooth devices by transmitting packets which include an active member address assigned during connection.

According to one Bluetooth embodiment, a number of modes are defined which correspond to the type of communication sequence occurring between devices. These modes include standby, inquiry, page, hold, and park. In this embodiment, all devices are in the standby mode prior to any communication. In standby mode, devices periodically listen for requests to join a piconet. The inquiry mode may be used by an initiating Bluetooth device to discover all the other in-range Bluetooth compatible devices when the identifying address of these other Bluetooth devices is unknown to the initiating Bluetooth device. The page mode may be used to establish communication with a specific Bluetooth compatible device whose unique address is known. During hold mode, a device may remain connected to the piconet while not currently communicating. During park mode, a device may surrender its active member address and may cease communications with the initiating Bluetooth device.

In one Bluetooth embodiment, a Bluetooth device (the master) initiates communication with one or more other Bluetooth devices (the slaves) by transmitting an inquiry message packet on 16 of 32 “inquiry hop” frequencies. The 32 inquiry hop frequencies may be common to all Bluetooth equipped devices. If no responses to the initial inquiry message are received, the master will transmits the inquiry message on the remaining 16 inquiry hop frequencies.

As mentioned previously, in one Bluetooth example, all Bluetooth equipped devices are in the standby mode prior to any communication. During standby mode, each Bluetooth device may periodically “wake up” to listen for inquiry messages. For example, each Bluetooth device may wake up once every 1.28 or 2.56 seconds to listen for inquiry messages on one of the 32 designated “inquiry hop” frequencies. Upon receiving an inquiry message, a slave may transmit an inquiry response to the master. The inquiry response includes, for example, the slave's unique address and other information. Upon receiving an inquiry response, the master may transmit a connection request to the responding slave. The slave may then transmit a connection response to the master. Once the slave transmits the connection response and a connection is established, the devices may exchange a more detailed description of the slave's capabilities by executing a service discovery protocol to exchange “Plug and Play” information. Plug and play information will enable the master to load “drivers” (software code) needed for communication between the master and the slave.

Another Bluetooth embodiment includes a security mechanism. The security mechanism is an authentication and encryption technique. The authentication may ensure, for example, that only devices owned by one particular entity are able to connect with other devices owned by that entity. The encryption may ensure, for example, that communication between Bluetooth devices is protected from eavesdroppers. Encryption may also prevent one device from “impersonating” another device. In the context of the present invention, the Bluetooth security mechanism may ensure (for example) that a particular pointer receiver only responds to wireless commands from a designated pointer transmitter.

Upon completing a connection process in accordance with the Bluetooth specification, the apparatus of FIG. 3 functions in a manner similar to that described above with reference to the video game application running on a computer. To begin the connection process, pointer receiver 324 (acting as a Bluetooth master) attempts to establish a connection with pointer transmitter 314 (the Bluetooth slave) by using transceiver 326 to transmit an inquiry message. If pointer transmitter 314 is within range and detects the inquiry message during a “wake up” period, pointer transmitter 324 then uses transceiver 310 to transmit an inquiry response to pointer receiver 324. Generally, the inquiry response may include a unique identifier assigned to the responding device and the general class (e.g., telephone, human interface device (HID), headset or computer) to which this particular device belongs. In this example, the inquiry response includes the unique identifier assigned to pointer transmitter 314 and an indication that pointer transmitter 314 is a HID.

Next, pointer receiver 324 transmits a connection request to pointer transmitter 314. The connection request is intended to be received by pointer transmitter 314 and thus may include the same unique identifier included within the inquiry response. Upon receiving the connection request, pointer transmitter 314 transmits a connection response to pointer receiver 324. The connection response may include information such as the manufacturer of pointer transmitter 314 and “Plug and Play” information. Examples of “Plug and Play” information include a vendor identification number (ID), a device ID, and a class code which identifies the device type (e.g., mouse, keyboard or hybrid device).

Upon receiving the connection response from transceiver 326, the host device connected to pointer receiver 324 may load one or more drivers which will enable the host device to communicate with pointer transmitter 314. At this time, the host device may also select one or more protocols for communicating with pointer transmitter 314 once the connection process is complete. The present invention may support high level protocols such as transmission control protocol/Internet protocol (TCP/IP) and HID descriptors.

Using one or more loaded drivers, and transceiver 326, the host device transmits a capabilities request to pointer transmitter 314. In response, pointer transmitter 314 transmits a capabilities response to pointer receiver 324. The capabilities response indicates to the host device that pointer transmitter 314 is capable of transmitting both voice and positioning data. Upon receiving the capabilities response, the host device may further configure drives which will enable the host to process the voice and positioning data received from pointer transmitter 314. Once any final driver configuration has been accomplished by the host device, the connection process is complete and the host may now receive voice and positioning data from pointer transmitter 314 through pointer receiver 324.

Voice signals received by microphone 302 are converted to digital signals by voice A/D converter 306. The digital output of voice A/D 306 is sent to Bluetooth transceiver 310. Bluetooth transceiver 310 encapsulates the digital output of voice A/D converter 306 into packets modulates the packets on a carrier frequency using frequency hopping, and sends these packets to antenna 312 which transmits the packets through the air to pointer receiver 324. Similarly, position A/D converter 314 converts position input signals from trackball 304 into digital signals which are encapsulated into packets and modulated on a carrier frequency using frequency hopping by Bluetooth transceiver 310. The modulated packets are transmitted through the air by antenna 312 to pointer receiver 324.

Packets received by antenna 316 are sent to Bluetooth transceiver 326. Bluetooth transceiver 326 demodulates the packets, removes the encapsulation and sends the data to the appropriate destination. Position data signals are sent to the host interface where they may be processed by an appropriate application program. Voice data is sent to speech engine 320. Speech engine 320 identifies the voice signal and generates a command output signal as described above with reference to FIG. 1. Depending on the speech engine employed, the digital
voice data may need to be converted back to an analog signal prior to being sent to the speech engine. Thus, voice D/A converter 318 is shown in dotted lines to indicate its optional status.

Depending on the application program running on the host, the command output signal from speech engine 320 may need to be converted to conventional mouse or keyboard output signals (as discussed above) prior to sending these signals to the application program. This conversion process may be accomplished using mapping function 322 as shown in FIG. 3 or this conversion may take place in the application program. Thus, the optional status of mapping function 322 is also indicated by dotted lines in FIG. 3.

Although several embodiments are specifically illustrated and described herein, it will be appreciated that modifications and variations of the present invention are covered by the above teachings and within the purview of the appended claims without departing from the spirit and intended scope of the invention. For example, although one embodiment described above entails transmitting separate signals corresponding to the position and voice inputs, the position and voice inputs may be transmitted and received using a single carrier signal. Additionally, the present invention may be implemented in the context of multi-user games. In a multi-user game embodiment more than one pointer transmitter may interact with the pointer receiver of the present invention. If this multi-user embodiment is implemented using Bluetooth technology, Bluetooth security enhancements may ensure only properly identified pointer transmitters interact with a particular pointer receiver.

Further, although one embodiment described above entails integrating the present invention with a system comprising a computer and computer monitor, the present invention is intended for use with screens, monitors and similar devices whether or not these devices are attached to computers, television sets, and etc. Similarly, the present invention is intended for use with any application program which displays data on a screen or monitor and is not limited to video game application programs. In addition, either the transmitter or the receiver may function as the master during an embodiment of the present invention which implements the Bluetooth method for establishing a connection. Further, although the speech engine is described and illustrated as included within the pointer receiver, the functions implemented by the speech engine may be accomplished from within the host device or outside the host device and still fall within the intended scope of the present invention.

1. A voice driven wireless device, comprising:
a first component including;
a pointing device receiving a position input;
a position transmitter adapted to be connected to said pointing device, said position transmitter receiving said positioning input from said pointing device and generating a first signal by modulating said received positioning input on a carrier frequency;
a microphone, said microphone receiving voice input;
a modulator adapted to be connected to said microphone, said modulator receiving said voice input from said microphone and generating a second signal by modulating said received voice input on said carrier frequency, wherein frequency hopping is used to determine said carrier frequency;
a voice transmitter adapted to be connected to said modulator, said voice transmitter receiving said second signal from said modulator; and
a first antenna adapted to be connected to said position transmitter and said voice transmitter, said antenna receiving said first signal from said position transmitter and receiving said second signal from said voice transmitter, said antenna transmitting said first signal and said second signal over said wireless medium.

2. The wireless device of claim 1, further comprising:
a second component adapted to be connected to a host device, said second component receiving said first signal and said second signal from said first component, using said first signal to generate a position output signal and using said second signal to generate a command output signal;
wherein said second component sends said position output signal and said command output signal to said host device.

3. The wireless device of claim 2, wherein said host device is a computer.

4. The wireless device of claim 2, wherein said host device is a television.

5. The wireless device of claim 1, wherein said pointing device is a trackball.

6. The wireless device of claim 1, wherein said pointing device is a joystick.

7. A voice driven wireless device, comprising:
a pointer transmitter including:
a pointing device, said pointing device receiving a position input;
a position analog-to-digital (A/D) converter adapted to be connected to said pointing device, said position A/D converter generating a first digital signal using said position input;
a microphone, said microphone receiving a voice input;
a voice A/D converter adapted to be connected to said microphone, said voice A/D converter generating a second digital signal using said voice input;
a first antenna; and
a first transceiver adapted to be connected to said voice A/D converter, said position A/D converter, and said antenna, said transceiver receiving said first digital signal from said position A/D converter and said second digital signal from said voice A/D converter, generating a first signal using said first digital signal, generating a second signal using said second digital signal, and transmitting said first signal and said second signal over said wireless medium using said antenna.

8. The wireless device of claim 7, wherein said transceiver generates said first signal and said second signal by modulating said first digital signal and said second digital signal on a carrier frequency.

9. The wireless device of claim 8, wherein said transceiver employs frequency hopping to determine said carrier frequency.

10. The wireless device of claim 9 wherein said first transceiver is a first Bluetooth transceiver.

11. The wireless device of claim 10, wherein said first Bluetooth transceiver is a Bluetooth slave.

12. The wireless device of claim 7, wherein said pointing device is a joystick.

13. The wireless device of claim 7, wherein said pointing device is a trackball.

14. The wireless device of claim 7 and further including a pointer receiver comprising:
a second antenna;
a speech engine; and
a second transceiver adapted to be connected to said antenna and adapted to be connected to said speech engine, said transceiver using said antenna to receive said first signal and said second signal from said first component, said transceiver demodulating said received first signal to generate said positioning output signal, said transceiver demodulating said received second signal and transmitting said demodulated second signal to said speech engine;
wherein said speech engine uses said demodulated second signal to generate said command output signal.

15. The wireless device of claim 14, further comprising:
a voice digital-to-analog (D/A) converter adapted to be connected between said transceiver and said speech engine, said voice D/A converter converting said demodulated second signal to an analog signal and transmitting said analog second signal to said speech engine.

16. The wireless device of claim 14, further comprising:
a mapping function adapted to be connected to said speech engine, said mapping function converting said command output signal to one of a conventional mouse signal and a conventional keyboard signal prior to transmitting said command output signal to said host device.

17. The wireless device of claim 15, further comprising:
a mapping function adapted to be connected to said speech engine, said mapping function converting said command output signal to one of a conventional mouse signal and a conventional keyboard signal prior to transmitting said command output signal to said host device.

18. The wireless device of claim 14 wherein said first and second transceivers are first and second Bluetooth transceivers.

19. The wireless device of claim 18, wherein said first Bluetooth transceiver is a Bluetooth slave and said second Bluetooth transceiver is a Bluetooth master.

20. A method for moving at least one object on a screen and executing commands at said at least one object's position, comprising the steps of:
receiving a position input signal and a voice signal;
transmitting said position input signal and said voice signal over a wireless medium;
receiving said position input signal and said voice signal;
generating a position output signal using said position input signal;
generating a command output signal using said voice signal;
transmitting said position output signal to a host device, said position output signal instructing said host device to move said at least one object on said screen of said host; and
transmitting said command output signal to said host device, said command output signal instructing said host to execute at least one command at a position of said at least one object, said transmitting at least one of said position input signal and said voice input signal over a wireless medium includes modulating at least one of said position input signal and said voice signal on a carrier frequency using frequency hopping to determine said carrier frequency.

21. The method of claim 20, wherein said host device is a computer.

22. The method of claim 20, wherein said host device is a television.

23. The method of claim 20, wherein both said position input signal and said voice signal are transmitted over said wireless medium as infrared signals.

24. The method of claim 20, wherein said signals are transmitted using Bluetooth technology.

25. An article comprising:
a storage medium having stored thereon instructions whose contents cause a system to move an image displayed on a screen and use voice inputs to execute commands at the image's position by:
receiving a position input signal and a voice signal;
transmitting said position input signal and said voice signal over a wireless medium;
receiving said position input signal and said voice signal;
generating a position output signal using said position input signal;
generating a command output signal using said voice signal;
transmitting said position output signal to a host device, said position output signal instructing said host device to move said at least one object on said screen of said host; and
transmitting said command output signal to said host device, said command output signal instructing said host to execute at least one command at a position of said at least one object, said transmitting at least one of said position input signal and said voice input signal over a wireless medium includes modulating at least one of said position input signal and said voice signal on a carrier frequency using frequency hopping to determine said carrier frequency.
